(19) United States
(12) Patent Application Publication
(10) Pub. No.: US 2025/0355648 A1
(43) Pub. Date: Nov. 20, 2025

(54) VERIFICATION DEVICE, VERIFICATION METHOD AND VERIFICATION PROGRAM

(71) Applicant: NIPPON TELEGRAPH AND TELEPHONE CORPORATION, Tokyo (JP)

(72) Inventor: Nariyoshi CHIDA, Musashino-shi, Tokyo (JP)

(73) Assignee: NIPPON TELEGRAPH AND TELEPHONE CORPORATION, Tokyo (JP)

(21) Appl. No.: 18/871,822

(22) PCT Filed: Jun. 7, 2022
(86) PCT No.: PCT/JP2022/022969

§ 371 Date: Dec. 5, 2024

(51) Int. Cl. G06F 8/41

(52) U.S. Cl. CPC G06F 8/42

(57) ABSTRACT

A verification device according to an embodiment includes a first determination unit and a second determination unit. The first determination unit determines whether a regular expression follows a syntax (for example, a syntax of a regular expression according to the Backus-Naur form) designated in advance. The second determination unit determines whether a condition (for example, real-world strong 1-unambiguity (RWS1U)) indicating that the processing time when the regular expression analyzes a character string is linear with respect to the length of the character string is satisfied.

### TECHNICAL FIELD

The present invention relates to a verification device, a verification method and a verification program.

### BACKGROUND ART

In the real world, a regular expression is implemented as a regular expression engine, and is used in various situations. For example, the regular expression engine is used to check whether a character string input by a user is an email address in a web application with a screen for inputting an email address. In addition, for example, the regular expression engine is adopted for sanitization of data transmitted from the outside, extraction of elements, a standard library of a general-purpose programming language, and the like.

Here, an analysis algorithm based on a backtracking method adopted in many regular expression engines has a disadvantage that a huge amount of time is required for processing depending on a combination of data to be analyzed and a regular expression. A Regular Expression Denial of Service (ReDoS) is known as a cyberattack that exploits such a disadvantage (reference: “Regular expression Denial of Service-ReDos”, https://owasp.org/www-community/attacks/Regular_expression_Denial_of_Service_-_ReDoS).

Note that a regular expression that operates in linear time on the regular expression engine with respect to the length of the character string to be matched is called an invulnerable regular expression. On the contrary, a regular expression that operates, for example, in exponential function time on the regular expression engine with respect to the length of the character string to be matched is called a vulnerable regular expression.

Conventionally, as a technique for removing a ReDoS threat, RFixer (see, for example, Non Patent Literature 1) for correcting an error of a language that is accepted by a regular expression is known. In addition, there is known a method of obtaining an invulnerable regular expression by converting a pure regular expression into a deterministic finite automaton once and back to a regular expression (see, for example, Non Patent Literature 2).

### CITATION LIST

### Non Patent Literature

Non Patent Literature 1: Rong Pan, Qinheping Hu, Gaowei Xu, and Loris D'Antoni. 2019. Automatic Repair of Regular Expressions. Proc. ACM Program. Lang. 3, OOPSLA, Article 139 (October 2019), 29 pages.
Non Patent Literature 2: Brink van der Merwe, Nicolaas Weideman, and Martin Berglund. 2017. Turning Evil Regexes Harmless. In Proceedings of the South African Institute of Computer Scientists and Information Technologists (SAICSIT' 17). Association for Computing Machinery, New York, NY, USA, Article 38, 10 pages.

### SUMMARY OF INVENTION

### Technical Problem

However, the conventional technique has a problem that it may not be possible to verify the certainty that vulnerability of a regular expression has been corrected.

### Solution to Problem

In order to solve the above problem and achieve the object, a verification device includes: a first determination unit that determines whether a regular expression follows a syntax designated in advance; and a second determination unit that determines whether a condition indicating that processing time when the regular expression analyzes a character string is linear with respect to a length of the character string is satisfied.

### Advantageous Effects of Invention

According to the present invention, it is possible to verify the certainty that the vulnerability of a regular expression has been corrected.

### BRIEF DESCRIPTION OF DRAWINGS

FIG. 1 is a diagram illustrating a configuration example of a correction device according to a first embodiment.

FIG. 2 is a diagram illustrating an example of a syntax of a regular expression.

FIG. 3 is a diagram illustrating examples of positive examples and negative examples.

FIG. 4 is a diagram describing a method for generating a set of character strings.

FIG. 5 is a diagram describing a method for synthesizing a regular expression.

FIG. 6 is a flowchart illustrating a flow of processing of the correction device according to the first embodiment.

FIG. 7 is a flowchart illustrating a flow of regular expression synthesis processing.

FIG. 8 is a diagram illustrating a configuration example of a verification device according to the first embodiment.

FIG. 9 is a diagram describing a method for determining RWS1U.

FIG. 10 is a diagram describing a syntax analysis tree.

FIG. 11 is a diagram illustrating an example of a path.

FIG. 12 is a flowchart illustrating a flow of processing of the verification device according to the first embodiment.

FIG. 13 is a flowchart illustrating a flow of RWS1U test processing.

FIG. 14 is a diagram illustrating an example of a computer that executes a verification program.

### DESCRIPTION OF EMBODIMENTS

Hereinafter, an embodiment of a verification device, a verification method and a verification program according to the present application will be described in detail with reference to the drawings. Note that the present invention is not limited to the embodiment described below.

### [Correction Device of First Embodiment]

First, a correction device that corrects vulnerability of a regular expression will be described. The verification device verifies the certainty that the regular expression has been corrected by the correction device.

For example, in a case where the verification result by the verification device indicates that there is a high possibility that the vulnerability of the regular expression has not been corrected, the regular expression is to be corrected by the correction device.

On the other hand, for example, in a case where the verification result by the verification device indicates that there is a high possibility that the vulnerability of the regular expression has been corrected, it is determined that the correction of the regular expression by the correction device is unnecessary.

In the embodiment, it is assumed that the correction device and the verification device are different devices. However, the verification device may be achieved as a part of the function of the correction device.

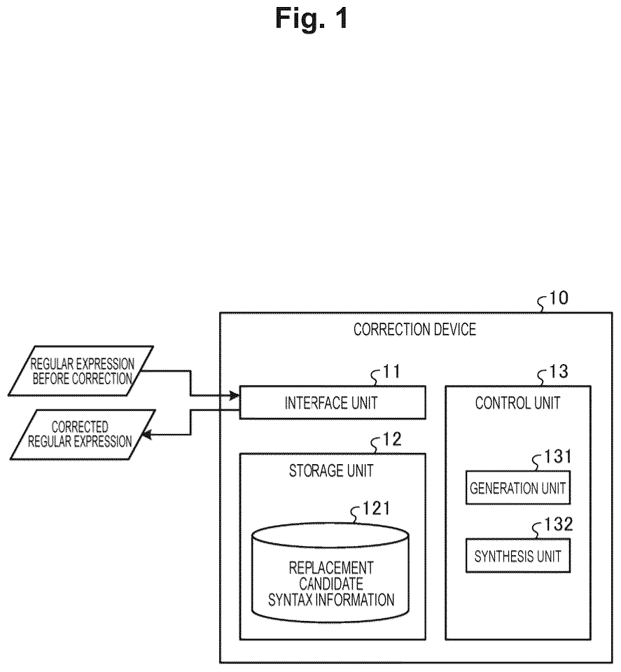

First, a configuration of a correction device according to a first embodiment will be described with reference to FIG. 1. FIG. 1 is a diagram illustrating an example of a configuration of a correction device according to the first embodiment. As illustrated in FIG. 1, a correction device 10 receives an input of a regular expression before correction, corrects the input regular expression, and outputs the corrected regular expression.

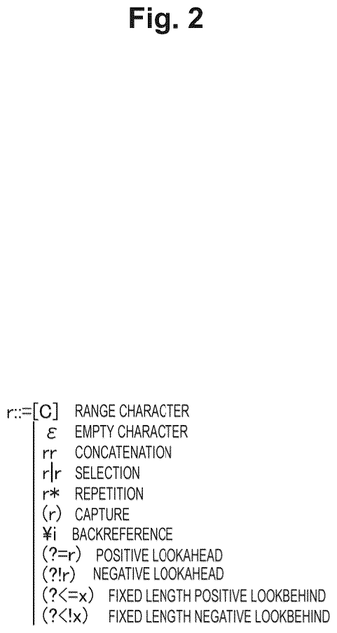

Here, the regular expression input to the correction device 10 is a regular expression with extension in the real world, and is assumed to follow the syntax defined in Backus-Naur form (BNF). FIG. 2 is a diagram illustrating an example of a syntax of a regular expression. A regular expression r in FIG. 2 is an example of the regular expression in the present embodiment. Note that, in the following description, “Y” in the regular expression may be replaced with backslash as appropriate.

In FIG. 2, “C” is a set of characters, “x” is a character string, and “i” is a natural number. The syntax in FIG. 2 is what is utilized in existing regular expression engines (reference: “Perldoc Browser”, https://perldoc.perl.org/perlre.html).

In addition, “.” is a symbol representing one arbitrary character. That is, “.” is a syntax sugar with respect to the range character “[C]” in FIG. 2. In addition, a set of characters that do not match the range character “[C]” can be written as “[\hat{ }C]”. In addition, the empty set is written as “[ ]”, which means that it does not match any character.

Returning to FIG. 1, each unit of the correction device 10 will be described. As illustrated in FIG. 1, the correction device 10 includes an interface unit 11, a storage unit 12, and a control unit 13.

The interface unit 11 is an interface for inputting/outputting data and communicating data. For example, the interface unit 11 receives an input of data from an input device such as a keyboard and a mouse. In addition, for example, the interface unit 11 outputs data to an output device such as a display and a speaker.

In addition, the interface unit 11 may be a device (for example, a network interface card (NIC)) for performing communication via a network.

The storage unit 12 is a storage device such as a hard disk drive (HDD), a solid state drive (SSD), or an optical disk. Note that the storage unit 12 may be a semiconductor memory capable of rewriting data, such as random access memory (RAM), flash memory, or non-volatile static random access memory (NVSRAM). The storage unit 12 stores an operating system (OS) and various programs executed by the correction device 10.

The storage unit 12 stores replacement candidate syntax information 121. The replacement candidate syntax information 121 is a set of regular expression or template syntaxes that are replaced with range characters or holes.

For example, the replacement candidate syntax information 121 is “□□, □|□, □*, (□), ¥i, (?=□), (?!□), (?<=□), (?<!□)”. Where, “□” is a hole. Holes and templates will be described below.

The control unit 13 controls entire the correction device 10. The control unit 13 is, for example, an electronic circuit such as a central processing unit (CPU), a micro processing unit (MPU), or a graphics processing unit (GPU), or an integrated circuit such as an application specific integrated circuit (ASIC) or a field programmable gate array (FPGA).

In addition, the control unit 13 includes an internal memory for storing programs and control data defining various processing procedures, and executes pieces of processing by using the internal memory. In addition, the control unit 13 functions as various processing units by various programs operating. For example, the control unit 13 includes a generation unit 131 and a synthesis unit 132.

The generation unit 131 generates positive examples, which are a set of character strings accepted by the regular expression before correction, and negative examples, which are a set of character strings rejected by the regular expression before correction.

Note that positive examples are an example of the first set. In addition, negative examples are an example of the second set. In addition, the regular expression before correction is an example of the first regular expression.

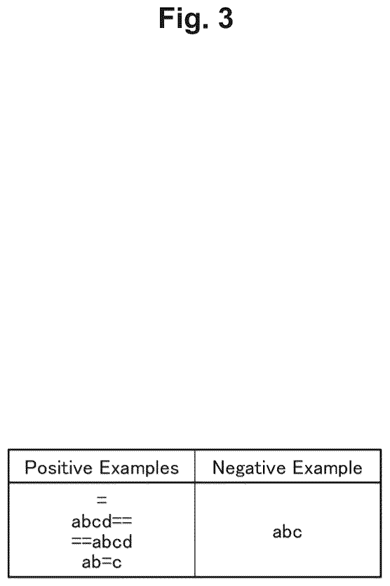

FIG. 3 is a diagram illustrating examples of positive examples and negative examples. Here, it is assumed that the regular expression before correction is “*.*=.*”. At this time, “=”, “abcd==”, “==abcd”, and “ab=c” included in the positive examples match (accepted by) the regular expression “.*.*=.*”. On the other hand, “abc” included in the negative examples does not match (rejected by) the regular expression “.*.*=.*”.

The generation unit 131 can enumerate all character strings in which characters having a specific length or less are combined, classify each character string into the positive examples when the character string is accepted by the regular expression, and classify each character string into the negative examples when the character string is rejected. Note that the generation unit 131 may generate the positive examples and negative examples using the method described in Non Patent Literature 1.

Here, when all the character strings are simply enumerated, a tremendous number of examples are generated. In order to avoid this, the generation unit 131 may generate the character string of the positive examples and the character string of the negative examples only from the characters appearing in the regular expression before correction.

For example, in a case where the regular expression is “ab [c−d]*”, the generation unit 131 generates a candidate character string by combining “a” and “b” with one character randomly selected from “[c,d]”.

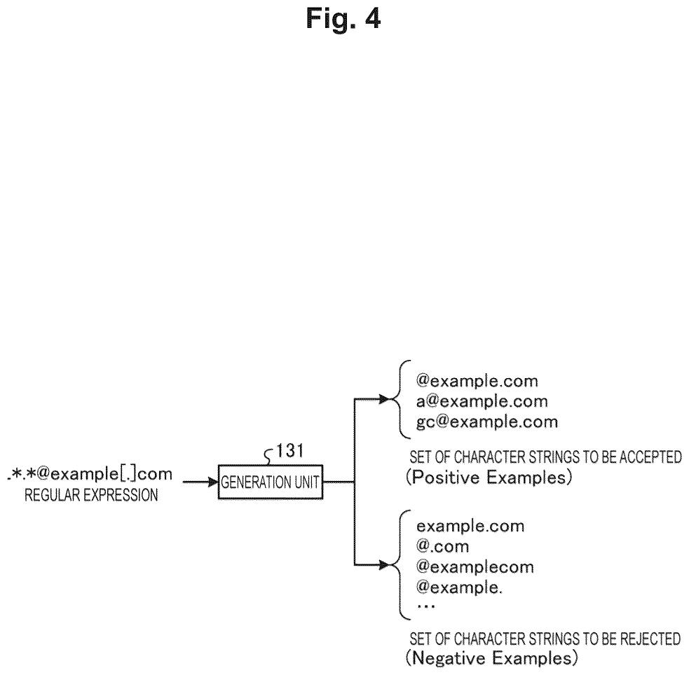

FIG. 4 is a diagram describing a method for generating a set of character strings. In the example of FIG. 4, the regular expression before correction is “.*.*@example[.]com”. In this case, the generation unit 131 classifies character strings “@example.com”, “a@example.com”, and “gc@example.com” accepted by the regular expression “.*.*@example[.]com” into the positive examples. On the other hand, the generation unit 131 classifies character strings “example.com”, “@.com”, “@examplecom”, “@example.”, and the like rejected by the regular expression “.*.*@example[.]com” into the negative examples.

The synthesis unit 132 synthesizes the corrected regular expression that is a regular expression obtained by replacing the range characters in the regular expression before correction with a predetermined syntax, that is, a regular expression that accepts a character string of the positive examples and rejects a character string of the negative examples. Note that the corrected regular expression is an example of the second regular expression. The processing by the synthesis unit 132 is roughly divided into a step of creating a template and a step of performing assignment to the template.

In the step of creating a template, the synthesis unit 132 creates a template by replacing range characters in a regular expression with placeholders.

In the step of performing assignment to the template, the synthesis unit 132 assigns a predetermined syntax to the placeholder and synthesizes an invulnerable regular expression. Hereinafter, the placeholder is referred to as a hole and denoted as “O”.

The synthesis unit 132 performs processing while holding a priority queue. The template stored in a queue is given priority according to the closeness to the regular expression before correction. For example, a template closer to the regular expression before correction is given a higher priority. In addition, the closeness to the regular expression may be represented by a sum of sizes of different subtrees between abstract syntax trees (ASTs) of the regular expression (see, for example, Non Patent Literature 1).

When extracting an element from the queue, the synthesis unit 132 preferentially extracts a template with the highest priority among the stored templates. At the start of the processing, the synthesis unit 132 stores the regular expression before correction in the queue as a template. Note that the priority of the regular expression before correction stored in the queue is inevitably the highest.

First, a step of creating a template executed by the synthesis unit 132 will be described. When the template extracted from the queue includes a range character, the synthesis unit 132 replaces the range characters included in the template with holes. Note that the range characters are represented as, for example, “[C]” or “.”. On the other hand, in a case where the template extracted from the queue includes holes, the synthesis unit 132 may replace any one of the holes with a predetermined syntax.

For example, the synthesis unit 132 creates templates “□*.*=.*”, “.*□*=.*”, and “.*.*=□*” obtained by replacing the range characters of the regular expression before correction “.*.*=.” stored in the queue as the template, and stores the templates in the queue. Note that it is assumed that the template extracted once is discarded.

In this manner, the synthesis unit 132 replaces at least some of the range characters in the regular expression before correction with holes, and synthesizes the corrected regular expression based on the template in which the replacement holes are further replaced with a predetermined syntax.

Further, the synthesis unit 132 can replace the holes with the syntax “□□”, “□|□”, “□*”, “(□)”, “¥i”, “(?=□)”, “(?!□)”, “(?<=□)”, or “(?<!□)” included in the replacement candidate syntax information 121. In this case, the synthesis unit 132 synthesizes the corrected regular expression based on the template (where, □ is a hole) in which the holes included in the template are replaced with any one of predetermined syntaxes including holes, that is, “□□”, “□|□”, “□*”, “(□)”, “¥i”, “(?=□)”, “(?!□)”, “(?<=□)”, and “(?<!□)”.

Next, a step of performing assignment to the template executed by the synthesis unit 132 will be described. Here, it is assumed that a step of creating a template by the synthesis unit 132 is repeated, and for example, a template “□*□*=.*” is created and stored in the queue. For example, the synthesis unit 132 obtains the template “□*□*=.*” by replacing the range character “.” on the left side of the template “□*.*=.*” with a hole.

The synthesis unit 132 searches for assignment of range characters satisfying conditions to the holes included in the template. For example, the synthesis unit 132 performs a search using Satisfiability Modulo Theories (SMT) solver (for example, Z3 solver) or the like.

When the template is “□*□*=.*” and the positive examples and the negative examples are as illustrated in FIG. 3, the synthesis unit 132 can obtain the assignment “[ ]*[\hat{ }=]*=.*” by the search. The synthesis unit 132 removes “[ ]” that is an empty set, and obtains a regular expression “[\hat{ }=]*=.*”.

The regular expression “[\hat{ }=]*=.*” accepts the positive examples in FIG. 3 and rejects the negative examples. In addition, since the regular expression “[\hat{ }=]*=.*” includes at most one place matching the same character, it can be said that the regular expression has an invulnerable property.

In the present embodiment, as described above, the regular expression that operates in a linear time on the regular expression engine with respect to the length of the character string to be matched is called an invulnerable regular expression. On the contrary, a regular expression that operates, for example, in exponential function time on the regular expression engine with respect to the length of the character string to be matched is called a vulnerable regular expression.

The synthesis of the invulnerable regular expression by the synthesis unit 132 uses a property obtained by improving the property of strongly one-unambiguous (reference: Christoph Koch and Stefanie Scherzinger. 2007. Attribute Grammars for Scalable Query Processing on XML Streams. The VLDB Journal 16, 3 (July 2007), 317-342.) devised by Koch and Scherzinger et al. also in accordance with extension in the real world.

Strongly one-unambiguous is a property that an operation to be processed next by the regular expression engine is uniquely determined when a character currently being analyzed is determined.

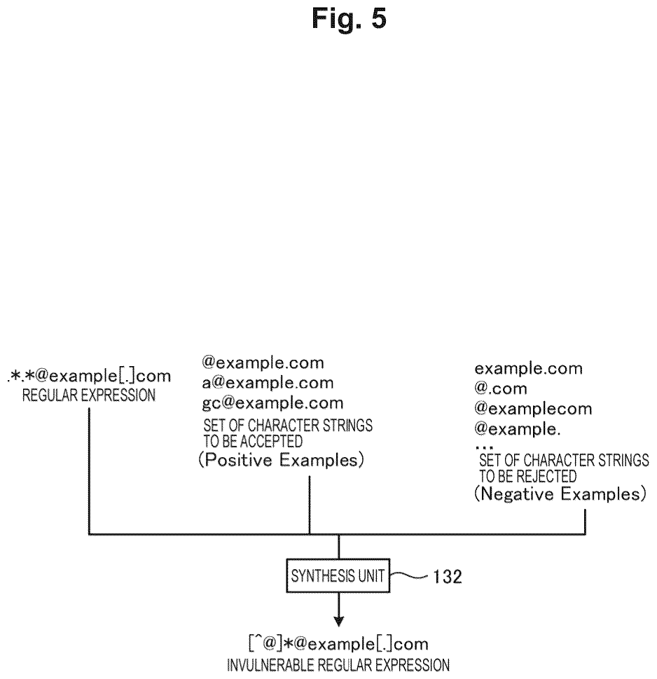

Similarly, in a case where the regular expression before correction is “.*.*@example[.]com”, as illustrated in FIG. 5, the synthesis unit 132 can obtain the invulnerable regular expression “[\hat{ }@]*@example[.]com”.

### [Flow of Processing of Correction Device]

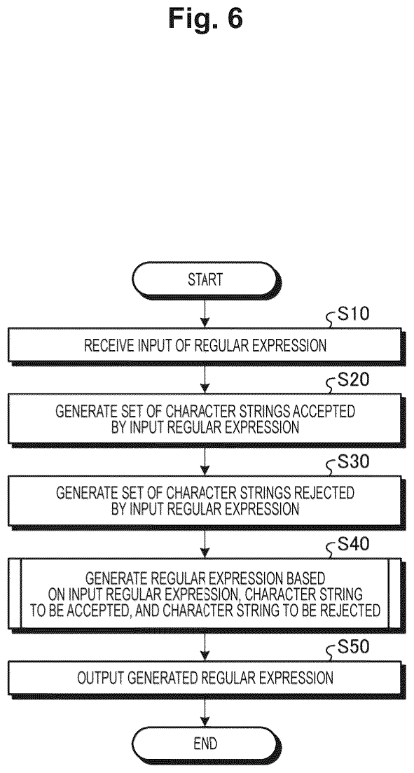

FIG. 6 is a flowchart illustrating a flow of processing of the correction device according to the first embodiment. First, the correction device 10 receives an input of a regular expression (step S10).

Next, the correction device 10 generates a set of character strings (positive examples) accepted by the input regular expression (step S20). In addition, the correction device 10 generates a set of character strings (negative examples) rejected by the input regular expression (step S30).

For example, the correction device 10 can create an extended automaton from the input regular expression before correction, and generate a set of character strings so as to cover all paths of the extended automaton.

Subsequently, the correction device 10 generates (synthesizes) a regular expression based on the input regular expression, the character string to be accepted, and the character string to be rejected (step S40). Then, the correction device 10 outputs the generated regular expression (step S50).

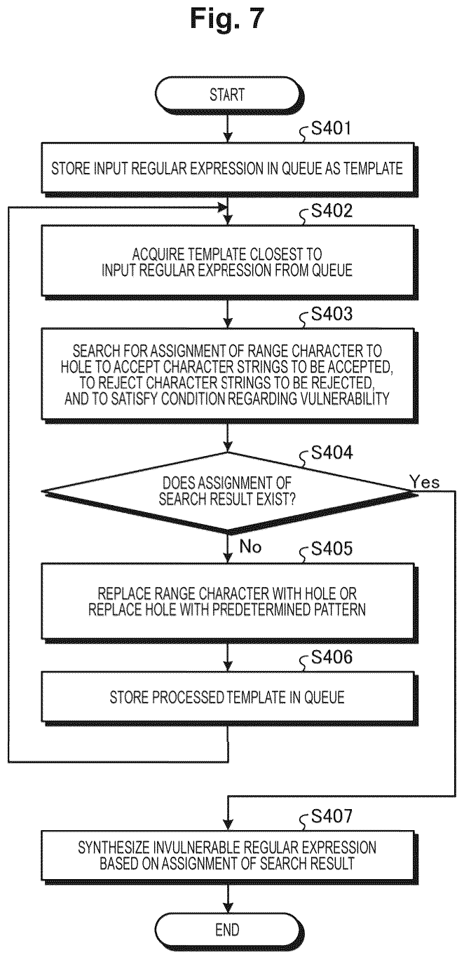

FIG. 7 is a flowchart illustrating a flow of regular expression synthesis processing. The processing of FIG. 7 corresponds to step S40 of FIG. 6. First, the correction device 10 stores the input regular expression in a queue as a template (step S401).

Next, the correction device 10 acquires a template closest to the input regular expression from the queue (step S402).

Subsequently, the correction device 10 searches for an assignment of a range character to the hole to accept the character strings to be accepted, to reject the character strings to be rejected, and to satisfy the condition regarding the vulnerability (step S403).

The correction device 10 determines whether the assignment of the search result exists (step S404). In a case where the assignment of the search result does not exist (step S404, No), the correction device 10 replaces the range character with the hole or the hole with a predetermined pattern (step S405). The predetermined pattern is, for example, a syntax such as “□□”, “□|□”, “□*”, “(□)”, “¥i”, “(?=□)”, “(?!□)”, “(?<=□)”, or “(?<!□)”. Note that, in a case where the input regular expression stored in the queue in step S401 is the target of the search in step S403, it is considered that there is no assignment (No) in step S404.

Then, the correction device 10 stores the template processed in step S405 in the queue (step S406). The processed template here is a template in which the range character is replaced with the hole or a template in which the hole is replaced with a predetermined pattern.

On the other hand, in a case where the assignment of the search result exists (step S404, Yes), the correction device 10 synthesizes an invulnerable regular expression based on the assignment of the search result (step S407).

### [Effects of Correction Device]

As described above, the generation unit 131 of the correction device 10 generates a first set that is a set of character strings accepted by the first regular expression and a second set that is a set of character strings rejected by the first regular expression. The synthesis unit 132 synthesizes a second regular expression that is a regular expression obtained by replacing range characters in the first regular expression with a predetermined syntax, that is, a regular expression that accepts character strings of the first set and rejects character strings of the second set. As described above, the correction device 10 performs correction including a syntax such as lookahead, lookbehind, and backreference, which are extensions widely used in the real world. Therefore, according to the present embodiment, it is possible to correct the vulnerability of the regular expression used in the real world.

Further, according to the present embodiment, it is possible to ensure that a regular expression used in a web service or the like is not vulnerable, and it is possible to protect a service from a ReDoS threat.

In addition, the generation unit 131 generates the character string of the first set and the character string of the second set from only the characters appearing in the first regular expression. As a result, the correction device 10 can efficiently create a set of character strings (positive examples) accepted by the input regular expression and a set of character strings (negative examples) rejected by the input regular expression.

In addition, the synthesis unit 132 replaces at least some of the range characters in the first regular expression with placeholders, and synthesizes the second regular expression based on the template in which the replacement placeholders are further replaced with a predetermined syntax. As a result, the correction device 10 can eliminate the vulnerability by the minimum replacement.

In addition, the synthesis unit 132 synthesizes the second regular expression based on a template (where is a placeholder) in which the placeholder included in the template is replaced with any one of predetermined syntaxes including the placeholder, that is, “□□”, “□|□,” “□*,” “(□),” “¥i,” “(?=□),” “(?!□),” “(?<=□),” and “(?<!□)”. As a result, the correction device 10 can replace the portion causing the vulnerability in the regular expression with a syntax having no vulnerability.

### [Verification Device of First Embodiment]

Next, a verification device for verifying whether the vulnerability of the regular expression has been corrected will be described.

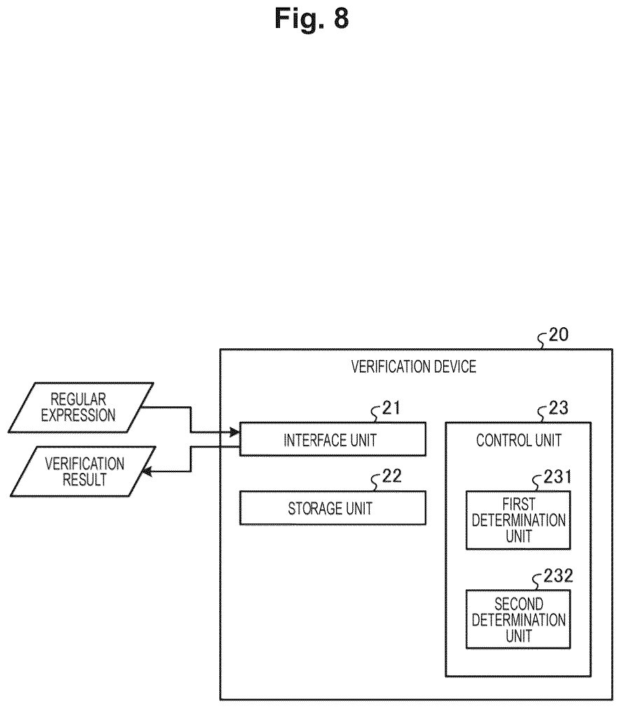

First, a configuration of a verification device according to the first embodiment will be described with reference to FIG. 8. FIG. 8 is a diagram illustrating an example of a configuration of a verification device according to the first embodiment. As illustrated in FIG. 8, a verification device 20 receives an input of a regular expression, and outputs a result of verifying whether the vulnerability of the input regular expression has been corrected.

Here, the regular expression input to the verification device 20 does not necessarily follow the Backus-Naur form. In addition, it is assumed that whether the regular expression input to the verification device 20 has been corrected by the correction device 10 is unknown.

As illustrated in FIG. 8, the verification device 20 includes an interface unit 21, a storage unit 22, and a control unit 23.

The interface unit 21 is an interface for inputting/outputting data and communicating data. For example, the interface unit 21 receives an input of data from an input device such as a keyboard and a mouse. In addition, for example, the interface unit 21 outputs data to an output device such as a display and a speaker.

In addition, the interface unit 21 may be a device (for example, NIC) for performing communication via a network.

The storage unit 22 is a storage device such as an HDD, an SSD, or an optical disc. Note that the storage unit 22 may be a data rewritable semiconductor memory such as RAM, flash memory, or NVSRAM. The storage unit 22 stores an OS and various programs executed by the verification device 20.

The control unit 23 controls the entire verification device 20. The control unit 23 is, for example, an electronic circuit such as a CPU, an MPU, or a GPU or an integrated circuit such as an ASIC or an FPGA.

In addition, the control unit 23 includes an internal memory for storing programs and control data defining various processing procedures, and executes each processing using the internal memory. In addition, the control unit 23 functions as various processing units by various programs operating. For example, the control unit 23 includes a first determination unit 231 and a second determination unit 232.

The first determination unit 231 determines whether the regular expression follows a syntax designated in advance. In addition, the second determination unit 232 determines whether a condition indicating that the processing time when the regular expression analyzes the character string is linear with respect to the length of the character string is satisfied.

That is, the verification by the verification device 20 is achieved by two-stage determination by the first determination unit 231 and the second determination unit 232. In addition, the first determination unit 231 performs a simpler test than the second determination unit 232.

In a case where it is determined by the first determination unit 231 that the designated syntax is followed and it is determined by the second determination unit 232 that the condition is satisfied, the verification device 20 outputs a verification result that the vulnerability of the regular expression has been corrected (or there is a high possibility that the vulnerability has been corrected).

Conversely, in a case where it is determined by the first determination unit 231 that the designated syntax is not followed and it is determined by the second determination unit 232 that the condition is not satisfied, the verification device 20 outputs a verification result that the vulnerability of the regular expression has not been corrected (or there is a high possibility that the vulnerability has not been corrected).

The first determination unit 231 determines whether the input regular expression includes the operators illustrated in FIG. 2. In this case, it can be said that the first determination unit 231 determines whether the regular expression follows the syntax of the regular expression according to the Backus-Naur form.

Note that, the first determination unit 231 can perform determination using a known syntax analyzer such as ANother Tool for Language Recognition (ANTLR) (reference: https://www.antlr.org/).

In a case where the regular expression satisfies RWS1U (reference: “Repairing DoS Vulnerability of Real-World Regexes”, https://www.computer.org/csdl/proceedings-article/sp/2022/131600b049/1A4Q3TnrBZK), the second determination unit 232 determines that the condition is satisfied.

RWS1U ensures that the processing time when the regular expression analyzes the character string is linear with respect to the length of the character string.

This is a sufficient condition for ensuring that the processing time is always linear with respect to the input length even when the regular expression is input to the regular expression engine together with an arbitrary input.

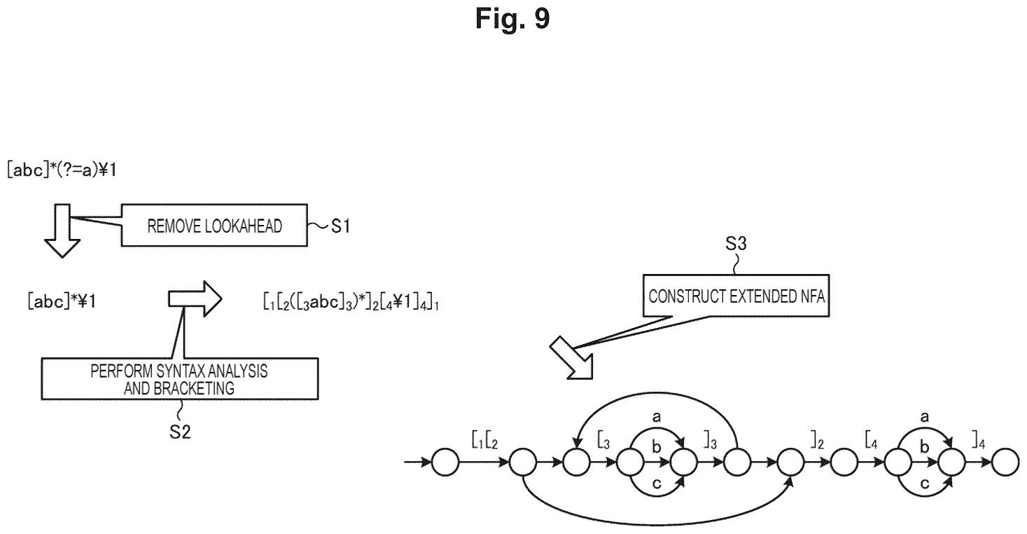

A method for determining whether the regular expression satisfies RWS1U will be described with reference to FIG. 9. FIG. 9 is a diagram describing a method for determining RWS1U.

First, as illustrated in FIG. 9, the second determination unit 232 removes lookahead from the input regular expression (step S1). The second determination unit 232 replaces lookahead with an empty character ¿ to remove the lookahead.

Here, it is assumed that the input regular expression is “[abc]*(?=a)¥1”. In addition, the lookahead includes positive lookahead “(?=r)” and negative lookahead “(?!r)” illustrated in FIG. 2.

Next, the second determination unit 232 performs bracketing on the regular expression from which the lookahead has been removed (step S2). Specifically, the second determination unit 232 converts the regular expression into a syntax analysis tree (AST), allocates a unique number i to each vertex of the syntax analysis tree, encloses the vertices with brackets “[ᵢ . . . ]ᵢ”, and converts the syntax analysis tree back to the regular expression.

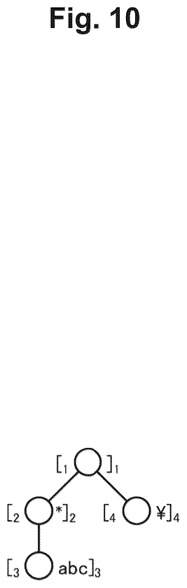

FIG. 10 is a diagram describing a syntax analysis tree. As illustrated in FIG. 10, the second determination unit 232 converts the regular expression “[abc]*¥1” from which the lookahead has been removed into a syntax analysis tree, and encloses each vertex with brackets. Then, the second determination unit 232 converts the syntax analysis tree back to the regular expression “[₁[₂([₃abc]₃)*]₂[₄¥1]₄]₁”.

Then, the second determination unit 232 constructs a nondeterministic finite automaton (NFA) from the regular expression to which the brackets have been added by a method obtained by extending the Thompson's construction method (step S3).

Here, the second determination unit 232 checks whether there is a vertex on the NFA such that there is a plurality of different paths that can reach the same character only through the brackets and the & transition (transition of empty character). When such a vertex exists, the second determination unit 232 determines that the regular expression does not satisfy RWS1U.

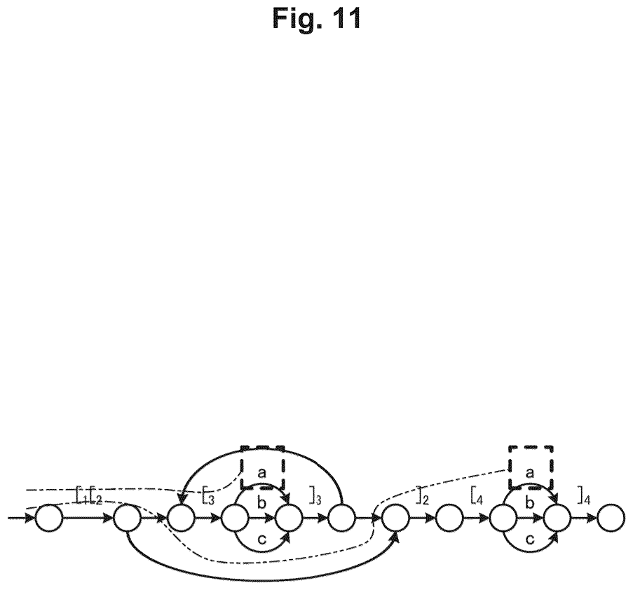

FIG. 11 is a diagram illustrating an example of a path. The NFA of FIG. 11 is constructed in step S3 of FIG. 9. As illustrated in FIG. 11, there are two paths for reaching “a” from the left end vertex. Therefore, the second determination unit 232 determines that the regular expression “[abc]*(?=a)¥1” does not satisfy RWS1U.

As described above, the second determination unit 232 converts the regular expression subjected to the removal of the lookahead and the addition of the brackets into the nondeterministic finite automaton, and determines that the condition is satisfied in a case where there is no vertex on the nondeterministic finite automaton such that there are different paths that can reach the same character only through the brackets and the transition of the empty character.

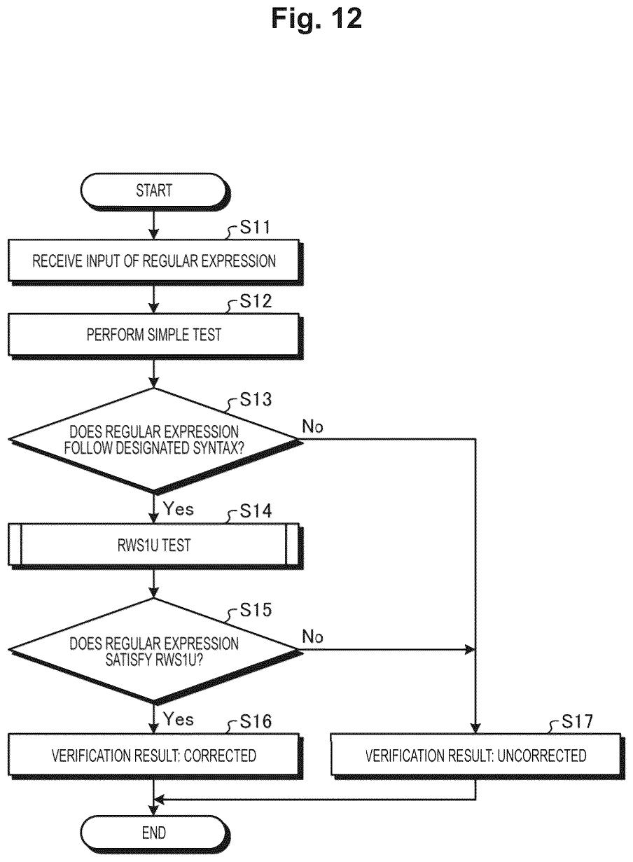

FIG. 12 is a flowchart illustrating a flow of processing of the verification device according to the first embodiment. As illustrated in FIG. 12, the verification device 20 first receives an input of a regular expression (step S11).

Next, the verification device 20 performs a simple test on the input regular expression (step S12). The simple test corresponds to the determination processing by the first determination unit 231.

As a result of the simple test, when the regular expression is not a predetermined syntax (step S13, No), the verification device 20 outputs that the vulnerability of the regular expression is uncorrected (step S17). For example, when the input regular expression does not follow the syntax of the regular expression according to the Backus-Naur form, the verification device 20 determines No in step S13, and otherwise, determines Yes in step S13.

On the other hand, when the regular expression is a predetermined syntax (step S13, Yes), the verification device 20 performs RWS1U test (step S14). The RWS1U test corresponds to the determination processing by the second determination unit 232.

As a result of the RWS1U test, when the regular expression does not satisfy RWS1U (step S15, No), the verification device 20 outputs that the vulnerability of the regular expression is uncorrected (step S17). For example, in a case where there is a vertex having a plurality of paths reaching the same character as illustrated in FIG. 11, the verification device 20 determines No in step S15, and otherwise, determines Yes in step S15.

On the other hand, when the regular expression satisfies RWS1U (step S15, Yes), the verification device 20 outputs that the vulnerability of the regular expression has been corrected (step S16).

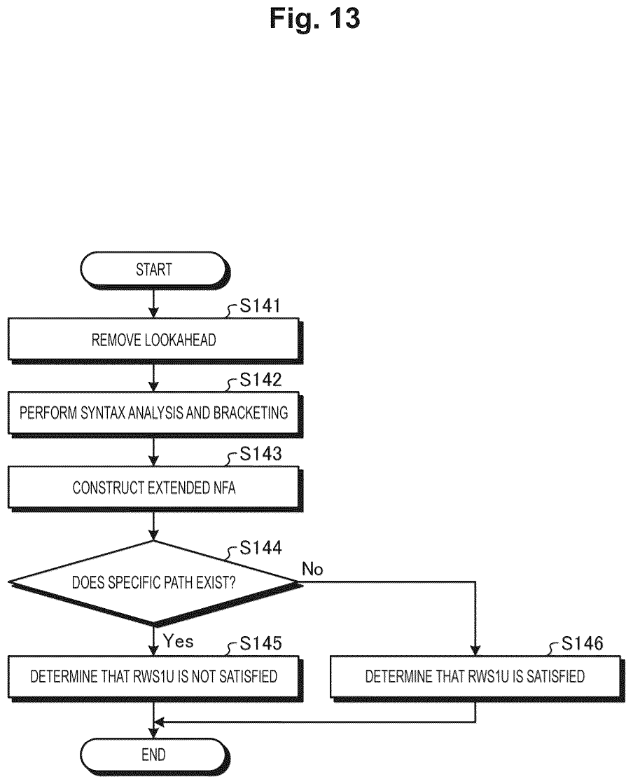

The flow of the RWS1U test (corresponding to step S14 of FIG. 12) will be described in detail with reference to FIG. 13. FIG. 13 is a flowchart illustrating a flow of RWS1U test processing.

First, the verification device 20 removes lookahead of the regular expression (step S141). Next, the verification device 20 performs syntax analysis and bracketing on the regular expression from which the lookahead has been removed (step S142).

Here, the verification device 20 constructs an NFA from the syntax analysis tree (step S143). Then, the verification device 20 determines whether a specific path exists on the NFA (step S144). For example, a specific path is a plurality of different paths that can reach the same character from a certain vertex.

When the specific path exists (step S144, Yes), the verification device 20 determines that the regular expression does not satisfy RWS1U (step S145).

On the other hand, when the specific path does not exist (step S144, No), the verification device 20 determines that the regular expression satisfies RWS1U (step S146).

### [Effects of Verification Device]

As described above, the first determination unit 231 of the verification device 20 determines whether the regular expression follows a syntax designated in advance. In addition, the second determination unit 232 determines whether a condition indicating that the processing time when the regular expression analyzes the character string is linear with respect to the length of the character string is satisfied. As a result, it is possible to verify the certainty that the vulnerability of a regular expression has been corrected.

Further, according to the embodiment, it is possible to evaluate the effectiveness of a proposed correction for the vulnerability of the regular expression or a technique for the correction, and contribute to avoiding the vulnerable regular expression.

In addition, the second determination unit 232 determines that the condition is satisfied when the regular expression satisfies RWS1U. For example, the second determination unit 232 converts the regular expression subjected to the removal of the lookahead and the addition of the brackets into the nondeterministic finite automaton, and determines that the condition is satisfied in a case where there is no vertex on the nondeterministic finite automaton such that there are different paths that can reach the same character only through the brackets and the transition of the empty character.

As a result, it is possible to narrow down the regular expression that needs to be corrected by the correction device 10 and improve the efficiency of the processing. Note that it is assumed that the regular expression corrected by the correction device 10 satisfies RWS1U.

By combining the correction device 10 and the verification device 20, it is possible to more efficiently perform the processing regarding the correction of the vulnerability of the regular expression. Based on the above embodiment, a correction system in which the correction device 10 and the verification device 20 are combined can be implemented.

That is, the correction system includes the correction device 10 and the verification device 20. The verification device 20 includes the first determination unit 231 that determines whether the first regular expression follows a syntax designated in advance, and the second determination unit 232 that determines whether the condition indicating that the processing time when the first regular expression analyzes the character string is linear with respect to the length of the character string is satisfied. The correction device 10 includes the generation unit 131 that generates the first set that is a set of character strings accepted by the first regular expression and a second set that is a set of character strings rejected by the first regular expression, when the first determination unit 231 determines that the first regular expression does not follow the designated syntax, or when the first determination unit 231 determines that the first regular expression follows the designated syntax and the second determination unit 232 determines that the condition is not satisfied for the first regular expression (for example, when the first regular expression does not satisfy RWS1U), and the synthesis unit 132 that synthesizes the second regular expression that is a regular expression obtained by replacing range characters in the first regular expression with a predetermined syntax, that is, a regular expression that accepts the character string of the first set and rejects the character string of the second set.

### [System Configuration and the Like]

In addition, each of components of the illustrated devices is functionally conceptual, and does not necessarily need to be physically configured as illustrated. That is, a specific form of distribution and integration of the devices is not limited to the illustrated form, and can be configured by functionally or physically distributing or integrating all or some thereof in any unit depending on various loads, use status, and the like. Further, the whole or any part of processing functions performed in the devices can be implemented by a central processing unit (CPU) and a program analyzed and executed by the CPU, or can be implemented as hardware by wired logic. Note that the program may be executed not only by a CPU but also by another processor such as a GPU.

In addition, among the pieces of processing described in the present embodiment, all or some of the pieces of processing described as being automatically performed can be manually performed, or all or some of the pieces of processing described as being manually performed can be automatically performed by a known method. Processing procedures, control procedures, specific names, and information including various types of data and parameters described in the above literature and drawings can be arbitrarily changed unless otherwise described.

### [Program]

As an embodiment, the verification device 20 can be implemented by installing a verification program for executing the verification processing described above as packaged software or online software in a desired computer. For example, by causing the information processing device to execute the verification program described above, it is possible to cause the information processing device to function as the verification device 20. The information processing device described here includes a desktop or laptop personal computer. In addition, the information processing device also includes a mobile communication terminal such as a smartphone, a mobile phone, and a personal handyphone system (PHS), a slate terminal such as a personal digital assistant (PDA), and the like.

In addition, the verification device 20 can also be implemented as a verification server device that uses a terminal device used by the user as a client and provides the client with a service related to the verification processing described above. For example, the verification server device is implemented as a server device that provides a verification service in which the regular expression is used as an input and a verification result indicating whether the vulnerability of the regular expression has been corrected is used as an output. In this case, the verification server device may be implemented as a web server, or may be implemented as a cloud that provides a service related to verification processing described above by outsourcing.

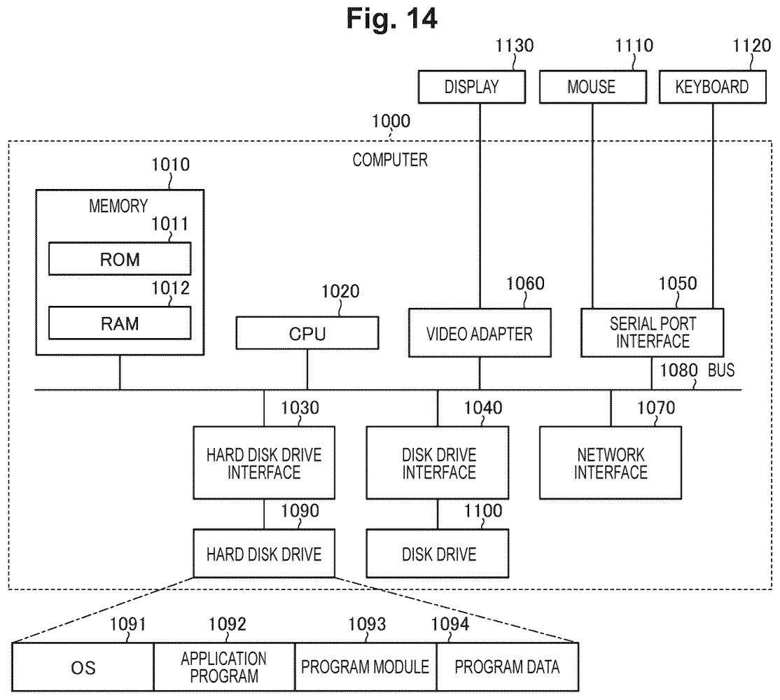

FIG. 14 is a diagram illustrating an example of a computer that executes a verification program. The computer 1000 includes a memory 1010 and a CPU 1020, for example. In addition, the computer 1000 includes a hard disk drive interface 1030, a disk drive interface 1040, a serial port interface 1050, a video adapter 1060, and a network interface 1070. These units are connected to each other via a bus 1080.

The memory 1010 includes read only memory (ROM) 1011 and random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected with, for example, a display 1130.

The hard disk drive 1090 stores, for example, an OS 1091, an application program 1092, a program module 1093, and program data 1094. That is, the program that defines each processing of the verification device 20 is implemented as the program module 1093 in which codes executable by the computer are described. The program module 1093 is stored in, for example, the hard disk drive 1090. For example, the program module 1093 for executing processing similar to the functional configuration in the verification device 20 is stored in the hard disk drive 1090. Note that the hard disk drive 1090 may be replaced with a solid state drive (SSD).

In addition, setting data used in the processing in the embodiment described above is stored in, for example, the memory 1010 or the hard disk drive 1090 as the program data 1094. Then, the CPU 1020 reads the program module 1093 and the program data 1094 stored in the memory 1010 or the hard disk drive 1090 to the RAM 1012 as necessary and executes the processing of the embodiment described above.

Note that the program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (local area network (LAN), wide area network (WAN), or the like). Then, the program module 1093 and the program data 1094 may be read by the CPU 1020 from another computer via the network interface 1070.

### REFERENCE SIGNS LIST

10 Correction device
11, 21 Interface unit
12, 22 Storage unit
13, 23 Control unit
20 Verification device
121 Replacement candidate syntax information
131 Generation unit
132 Synthesis unit
231 First determination unit
232 Second determination unit

1. A verification device comprising:
processing circuitry configured to:
determine whether a regular expression follows a syntax designated in advance; and
determine whether a condition indicating that processing time when the regular expression analyzes a character string is linear with respect to a length of the character string is satisfied.

2. The verification device according to claim 1, wherein the processing circuitry is further configured to determine that the condition is satisfied when the regular expression satisfies RWS1U.

3. The verification device according to claim 1, wherein the processing circuitry is further configured to convert the regular expression subjected to removal of lookahead and addition of brackets into a nondeterministic finite automaton, and determines that the condition is satisfied in a case where there is no vertex on the nondeterministic finite automaton such that there are different paths that can reach a same character only through the brackets and transition of an empty character.

4. A verification method executed by a verification device, the verification method comprising:
determining whether a regular expression follows a syntax designated in advance; and
determining whether a condition indicating that processing time when the regular expression analyzes a character string is linear with respect to a length of the character string is satisfied.

5. A non-transitory computer-readable recording medium storing therein a verification program that causes a computer to execute a process comprising:
determining whether a regular expression follows a syntax designated in advance; and
determining whether a condition indicating that processing time when the regular expression analyzes a character string is linear with respect to a length of the character string is satisfied.
